(19) United States
(12) Patent Application Publication
(10) Pub. No.: US 2022/0253249 A1
(43) Pub. Date: Aug. 11, 2022

(54) WORKLOAD-DEPENDENT AGE TRACKING FOR NON-VOLATILE MEMORY

(71) Applicant: Intel Corporation, Santa Clara, CA (US)

(72) Inventors: Vladimir MATVEYENKO, Camas, WA (US); Venkat Ramana Reddy GOGIREDDY, Portland, OR (US)

(21) Appl. No.: 17/728,776

(22) Filed: Apr. 25, 2022

(51) Int. Cl. G06F 3/06

(52) U.S. Cl. CPC G06F 3/0659; G06F 3/0679; G06F 3/061

(57) ABSTRACT

Workload-dependent age tracking can improve quality of service in non-volatile memory (NVM). In one example, an NVM controller includes an age counter for each memory access command in a queue. Instead of incrementing the age counters every clock cycle (or other predetermined number of clock cycles), the age counters are adjusted (e.g., incremented) at an aging rate that is based on an average rate of scheduled commands for the queue. Thus, aging of commands in the queues speeds up or slows down depending on the workload. By aging commands at the rate of commands being scheduled, the scenario in which many commands become “starved” at the same time can be avoided, improving QoS and reducing errors.

### FIELD

The descriptions are generally related to memory, and more particularly, to age tracking for non-volatile memory.

### BACKGROUND

Memory resources have innumerable applications in electronic devices and other computing environments. Memory can be volatile or non-volatile. A non-volatile memory (NVM) device is a type of memory whose state is determinate even if power is interrupted to the device. Examples of non-volatile memory technologies include NAND memory and cross-point memory.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing at least one implementation of the invention that includes one or more particular features, structures, or characteristics. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of an example of control logic with conventional age tracking.

FIGS. 2A and 2B are diagrams depicting examples of command arbitration and scheduling for two different workloads using conventional command aging.

FIG. 3 is a block diagram of an example of control logic that implements workload-dependent age tracking.

FIG. 4A is a block diagram of an example of a pending queue arbiter.

FIG. 4B is a block diagram of an example of an NVM scheduler.

FIG. 4C is a block diagram of an example of workload-dependent age tracking logic.

FIG. 5 is an example of a finite state machine (FSM) diagram for the workload-dependent age tracking logic.

FIG. 6 illustrates a flow diagram of an example of a method of workload-dependent command aging.

FIG. 7 is a diagram depicting an example of command arbitration and scheduling for a workload using workload-dependent command aging.

FIG. 8 is an example of a cross-point memory cell.

FIG. 9 illustrates an example of a portion of a cross-point memory cell array.

FIG. 10 is a block diagram of a system that can include a non-volatile memory device that implements workload-dependent aging techniques described herein.

FIG. 11 provides an exemplary depiction of a computing system that can include a non-volatile memory device that implements work-load dependent aging techniques described herein.

Descriptions of certain details and implementations follow, including a description of the figures, which may depict some or all of the embodiments described below, as well as discussing other potential embodiments or implementations of the inventive concepts presented herein.

### DETAILED DESCRIPTION

Techniques for workload-dependent age tracking for non-volatile memory are described herein.

In conventional nonvolatile memory (NVM), some traffic patterns may result in low quality of service (QoS). For example, viral workloads that are generated by a virus may flood the memory controller with patterns of memory commands to intentionally reduce quality of service, generate errors, and cause timeouts at the platform level. In order to avoid such QoS issues, some conventional NVM controllers include fixed or absolute age counters and starvation flags to track how long memory access commands have been waiting to be serviced. When a valid age counter overflows, the corresponding command is treated with a higher priority.

However, a fixed age counter may be insufficient to prevent QoS issues from some viral workloads. For example, a fixed age counter may not represent a true starvation condition. The viral workload may cause many commands to reach a pseudo-starvation state at the same time so that the pending queue arbiter cannot correctly choose the oldest entry. When many host commands are flagged as high priority, the NVM scheduler may not be able to guarantee QoS for internally generated media management commands. Additionally, a solution using fixed counters does not scale. Larger counters may improve QoS but are expensive in terms of area and power.

In contrast, workload-dependent age tracking can improve QoS with fewer gates than a fixed age counter. In one example, the NVM controller includes an age counter for each memory access command in a queue. Instead of incrementing the age counters every clock cycle (or other predetermined number of clock cycles), the age counters are incremented at an aging rate that is based on an average rate of scheduled commands for the queue. Thus, aging of commands in the queues speeds up or slows down depending on the workload. For example, if commands are being scheduled quickly without waiting in the queue, the aging rate is higher (e.g., faster). If commands are stalling or delayed in the queue (e.g., due to the memory not being able to absorb them fast enough), the aging rate slows down. By aging commands at the rate of commands being scheduled, the scenario in which many commands become starved at the same time can be avoided, improving QoS and reducing errors.

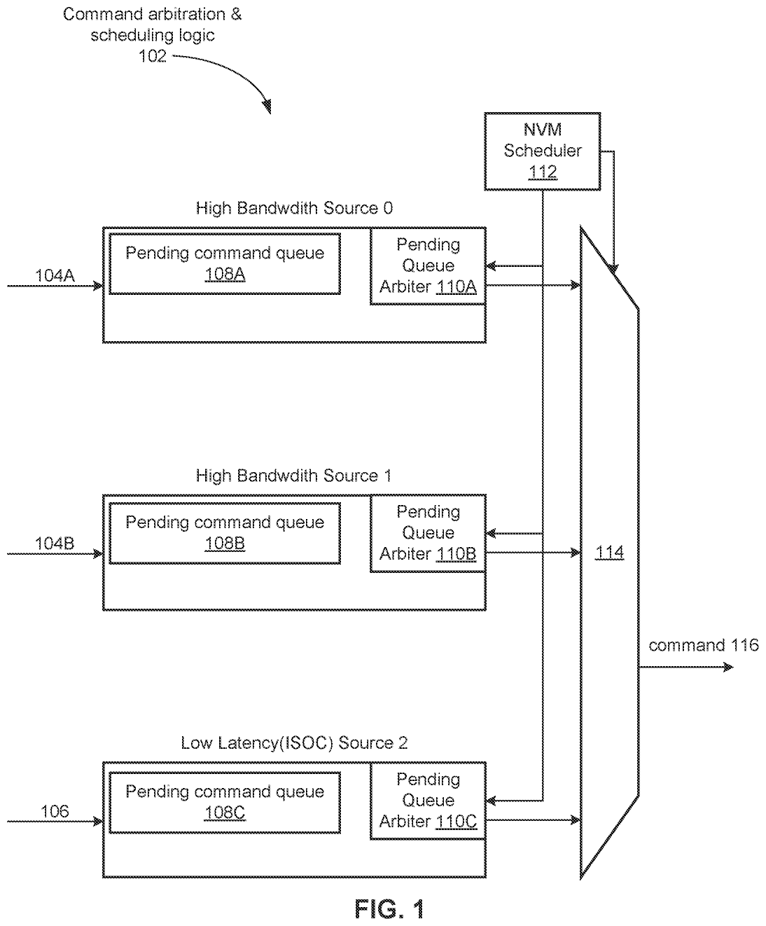

FIG. 1 is a block diagram of an example of conventional command and scheduling logic. In one example, the command and scheduling logic 102 is implemented in a memory-side controller (e.g., an internal memory controller). According to one example, the control logic 102 is implemented primarily in hardware (e.g., circuitry); however, some features of command arbitration and scheduling may be implemented in firmware that is run by the internal memory controller.

The control logic 102 of FIG. 1 includes three pending command queues 108A-108C. A pending command queue is a buffer for storing pending commands. Command queues 108A and 108B receive and store commands 104A and 104B, respectively, from one or more processors. Commands 104A and 104B received from one or more processors may be, for example, memory access commands. According to one example, the memory access commands may be considered “high bandwidth traffic” (traffic utilizing high bandwidth), and thus the pending command queues 108A and 108B may be considered “high bandwidth sources.” The pending command queue 108C receives and stores commands 106 that are internally generated, and that typically require low latency servicing. Thus, in one example, the queues 108A and 108B receive and store memory access commands 104A and 104B, and the queue 108C receives and stores internally generated media management commands.

The logic 102 implements a two-step arbitration process. First, an arbiter for each queue selects a command from its queue for scheduling. For example, the arbiter 110A selects a command from pending command queue 108A; arbiter 110B selects a command from pending command queue 108B; and arbiter 110C selects a command from pending command queue 108C. An NVM scheduler 112 then selects which queue will own the bus next, providing a select input to a multiplexor (MUX) 114. The command 116 selected by the scheduler 112 is scheduled for sending to the memory media for servicing. The arbiters 110A-110C typically select the oldest command for scheduling, and if the command is starved, the command will be flagged to the scheduler as being high priority. In one example, all media management commands selected from the queue 108C are flagged as high priority in order to ensure low latency servicing.

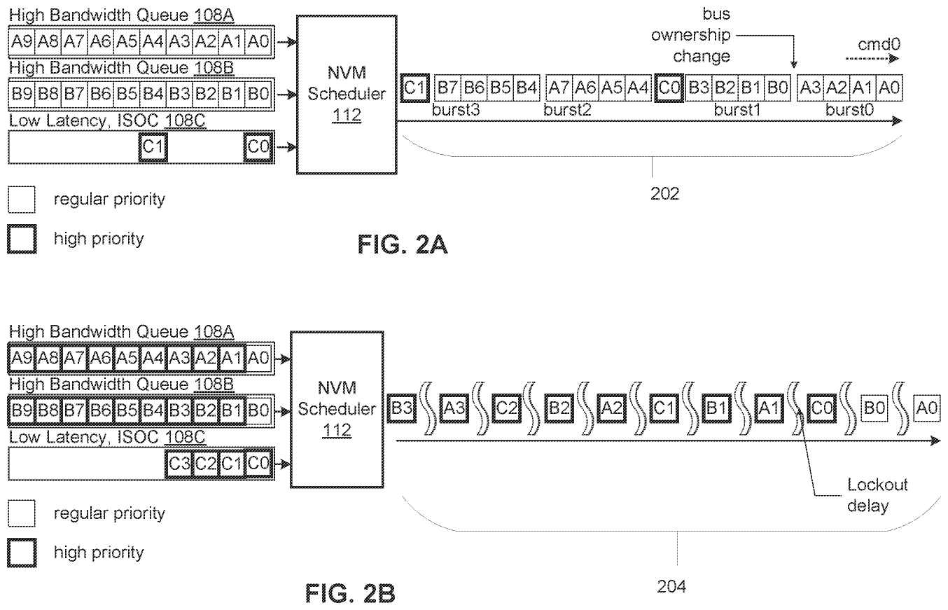

FIGS. 2A and 2B are diagrams depicting examples of command arbitration and scheduling for two different workloads using conventional command aging. FIG. 2A illustrates a high-bandwidth workload. In one example, in a high-bandwidth workload, commands are interleaved in such a way to target different NVM partitions and reduce overall command latency. Low latency commands are scheduled quickly, whenever there is an arbitration between bursts. In high-bandwidth workloads, commands do not have time to age, so age counter values play almost no role in QoS.

For example, referring to FIG. 2A, the queue 108A has pending commands A0-A9, the queue 108B has pending commands B0-B9, and the queue 108C has pending commands C0 and C1. None of the commands from the high-bandwidth queues 108A and 108B are starved, and therefore those commands are not flagged as high priority. The NVM scheduler 112 receives commands selected from each of the queues 108A-108C and selects one of the queues as a source of commands for scheduling. The resulting scheduled commands 202 includes alternating bursts 0-3 of commands from the high-bandwidth queues and the low-latency commands are scheduled without excessive delays.

In contrast, FIG. 2B illustrates a low-bandwidth or starvation workload. Unlike the high-bandwidth workload, the low-bandwidth workload commands are targeting the same NVM partition. In one example, only one command can be sent to the same NVM partition at a time, while the other commands wait. As the delay between commands is long, the serial nature of this workload causes all commands in the pending queues to reach a starvation condition and high-priority flags are asserted. When all incoming commands contain high priority flags, the NVM scheduler cannot accurately determine which command is the oldest and starts to operate in a round-robin fashion. Hence, the low-latency commands receive a poor QoS and may fail to meet platform requirements.

For example, referring to FIG. 2B, the first command in the queues 108A and 108B are regular priority (e.g., not high priority) and are scheduled for servicing by the memory. The remaining commands in the queues 108A and 108B are unavailable for immediate scheduling (e.g., due to targeting the same partition as the commands A0 or B0, resulting in lockout delays), and therefore are waiting in the queues. Age counters that increment every clock cycle eventually roll over (e.g., reaches the maximum count and starts over), resulting in all the other commands in the queues 108A and 108B reaching a starved condition. Once all the commands are starved, all commands selected by the pending queue arbiters are flagged as high priority. All commands being flagged as high priority can result in invalid command ordering (e.g., the low latency commands are not prioritized) and significant delays in scheduling the low latency commands from the queue 108C. Therefore, the fixed age counter tracking can result in many entries going into starvation quickly, which affects the low-latency command quality of service. Thus, the scheduled commands 204 in FIG. 2B have an invalid order in which the media management commands are delayed by regular traffic.

In contrast, a memory controller with workload-dependent age tracking can minimize the usage of high-priority flags for high-bandwidth traffic to improve QoS for low latency commands such as media management commands.

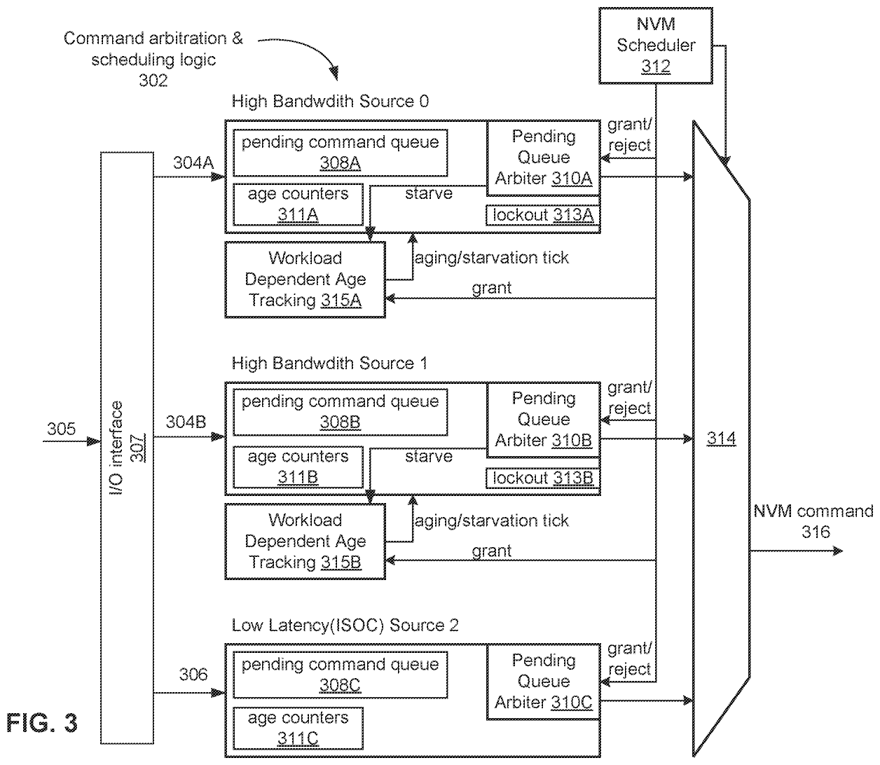

FIG. 3 is a block diagram of an example of control logic that implements workload-dependent age tracking. In one example, the control logic 302 is implemented in a memory-side controller (e.g., an internal memory controller). According to one example, the control logic 302 is implemented primarily in hardware logic (e.g., circuitry); however, some features of command arbitration and scheduling may be implemented in firmware that is run by the internal memory controller.

Like the example in FIG. 1, the control logic 302 of FIG. 3 includes multiple queues (e.g., three pending command queues 308A-308C). However, other examples may include fewer than three or more than three command queues (e.g., two queues, four queues, or another number of pending command queues). The control logic 302 includes input/output (I/O) interface logic 307 to receive commands 305 from one or more processors. The commands received from one or more processors are stored in one or more pending command queues. The queues 308A-308C share resources of the NVM, such as a command bus, data bus, as well as access to partitions and ranks of the NVM.

The control logic 302 includes queues for both memory access commands from a processor and a queue for miscellaneous or media management commands that are internally generated. Commands 304A and 304B from one or more processors may be, for example, memory access commands. Typical memory access commands include commands for reading from or writing to memory (e.g., read commands, write commands, and read-modify-write commands). In one example, the logic 302 includes a separate queue for each type of memory access command (e.g., the pending command queue 308A to store read commands, and the pending command queue 308B to store write commands). According to one example, the memory access commands may be considered “high bandwidth traffic” (traffic utilizing high bandwidth), and thus the pending queues 308A and 308B may be considered “high bandwidth sources.” The pending command queue 308C receives and stores commands 306 that are internally generated, and that typically require low latency servicing. For example, media management commands that manage the memory media to ensure low-error media operation typically need to be serviced without significant delay.

Also like in FIG. 1, the logic 302 implements a two-step arbitration process. First, an arbiter for each queue selects a command from its queue for scheduling. For example, the arbiter 310A selects a command from pending queue 308A; arbiter 310B selects a command from pending queue 308B; and arbiter 310C selects a command from pending queue 308C. Commands are typically available for scheduling if they have not been placed in lockout mode (e.g., due to prior rejection by the scheduler 312). In one example, the commands stored in the queue 308C require low latency, and therefore all commands selected from the queue 308C are flagged as high priority.

The NVM scheduler 312 then selects which queue will own the bus next, providing a select input to a multiplexor (MUX) 314. In one example, the scheduler 312 selects the high priority command for scheduling. In the event that multiple commands are flagged as high priority, the scheduler can select one of the high priority commands in accordance with a policy, such as a round robin selection policy. The command 316 selected by the NVM scheduler 312 is scheduled for sending to memory for servicing.

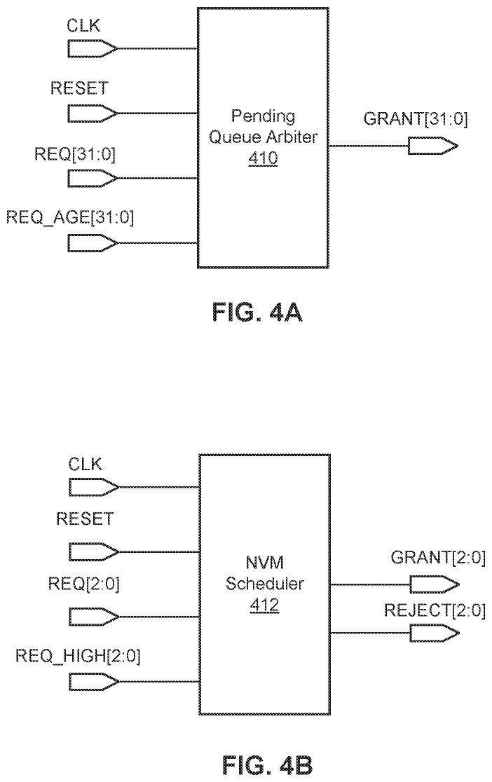

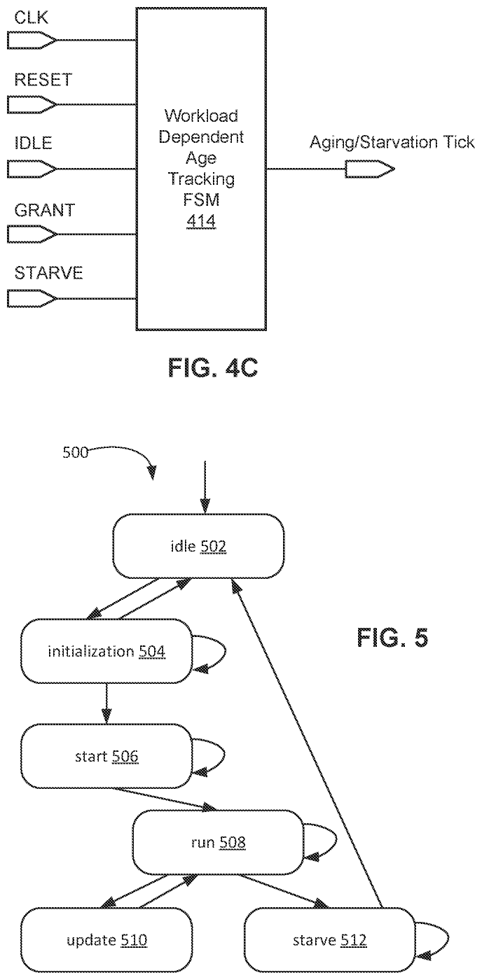

FIG. 4A is a block diagram of an example of a pending queue arbiter 410 (e.g., the arbiters 310A-310C of FIG. 3). FIG. 4B is a block diagram of an example of an NVM scheduler 412 (e.g., the scheduler 312 of FIG. 3). Referring to FIG. 4A, the arbiter receives a clock signal (CLK), a reset signal (RESET), a request signal (REQ[31:0]), and an age signal (REQ_AGE[31:0]). The request signal indicates which entries in the queue store valid commands. The age signal indicates which command(s) are the oldest. In one example, the age signal is received from the age counters for the corresponding queue (e.g., the age counters 311A-311C). The pending queue arbiter 410 chooses the next oldest entry from the corresponding pending command queue. In one example, the choice is made based on entry's age and its location in the queue. For example, when several entries have the same age, the next entry would be chosen using a round-robin scheme. The pending queue arbiter 410 outputs a grant signal to indicate which of the pending commands (e.g., which entry in the corresponding queue) was selected.

The entry selected by the arbiter 410 may or may not be accepted by the NVM scheduler 412. For example, referring to FIG. 4B, the NVM scheduler 412 selects the NVM source to own the bus and transmit one or more NVM commands. The NVM scheduler 412 in FIG. 4B receives the clock signal (CLK), the reset signal (RESET), a request signal (REQ[2:0]), and a high priority signal (REQ HIGH[2:0]). The request signal from the pending queue arbiters indicates whether a valid command was selected by each of the arbiters for arbitration. The high priority signal indicates whether the selected command from each of the arbiters has high priority or not. In one example, when any NVM source is using a high priority request, it would be granted NVM bus even if an active burst is in progress. When sources are not using high priority, then a round-robin priority scheme is used. In one such example, when all sources are using high priority, then a round-robin priority scheme is used. The scheduler outputs a grant signal (GRANT[2:0]) and reject signal (REJECT[2:0]) to indicate which command was selected for scheduling.

In one example, a rejection of the selected memory access command is received, the rejected command is placed in a lockout mode for a predetermined time. Placing a command in lockout mode can include, for example, setting a lockout bit or other means to indicate the command is locked out. A command in the lockout mode will not be selected for scheduling until it exits lockout mode (e.g., until a corresponding lockout bit is cleared). Once the lockout delay is over, it can be arbitrated again. In one example, the lockout delay is aligned with NVM media partition lockout delay. Placing rejected commands in lockout mode helps other command entries that target available partitions to get scheduled and improves overall performance.

Referring again to arbitration at the queue-level, the arbiters 310A-310C typically select the oldest available command for scheduling. Thus, each of the arbiters 310A-310C select a command based on the ages of the commands stored in the corresponding pending command queues 308A-308C. For example the arbiter 310A selects the oldest memory access command from the pending command queue 308A. The age of each entry in a pending command queue is tracked with an age counter. For example, the age of commands in queue 308A is tracked with age counters 311A; the age of commands in queue 308B are tracked with age counters 311B; and the age of commands in queue 308C are tracked with age counters 311C. In one example, the age counters are incremented to indicate aging (i.e., the time elapsed waiting in the queue). Incrementing an age counter involves increasing the value stored in the age counter by a discrete amount (e.g., by ‘1’ or another number). Once an age counter reaches a predetermined value or rolls over, the command is considered “starved.” Alternatively, instead of incrementing an age counter to track aging, an age counter can be implemented to start at an initial high value and be decremented. In such an example, the command could be considered starved when the age counter reaches zero or another predetermined value that is lower than the initial value. Regardless of whether the age counter is incremented or decremented to track aging, if the command is starved, the command will be flagged to the scheduler as being high priority. Note that the following description refers to a counter that is incremented, however, the descriptions apply to counters that are adjusted by incrementing or decrementing.

Unlike conventional age counters that are incremented every clock cycle (or other predetermined time), the age counters 311A and 311B are incremented at an aging rate based on the average rate of scheduled commands for the queue. The aging rate for the counters 311A and 311B speeds up or slows down based on how quickly commands for that queue are being scheduled. Thus, the aging rate increases when the average rate of scheduled commands for the queue increases, and the aging rate decreases when the average rate of scheduled commands for the queue decreases.

Workload-dependent age tracking logic 315A and 315B determines the aging rate for the counters 311A and 311B, respectively. FIG. 4C is a block diagram of workload-dependent age tracking logic 414. The workload-dependent age tracking logic 414 receives the clock signal (CLK), the reset signal (RESET), an idle signal (IDLE), a grant signal (GRANT), and a starve signal (STARVE). The grant signal is received from the scheduler and indicates whether the entry selected by the arbiter from the corresponding queue was granted (e.g., selected by the scheduler for scheduling). The starve signal from the arbiter indicates whether an entry in the corresponding queue is starved.

Based on the grant signal, the logic 414 computes an average rate of commands scheduled from the corresponding queue and generates a signal (aging/starvation tick) to cause the corresponding counter to be incremented. In one example the age counter for each of the memory access commands in a queue is incremented after every X number of commands from the queue have been scheduled, wherein X is a positive integer greater than or equal to one. In one example, to determine the rate of scheduled commands, the logic 414 counts clock cycles between grants and re-computes the average scheduled command rate for the corresponding queue. In one example, the aging rate is based on a moving average of the rate of scheduled commands for the buffer. Therefore, in one example, the logic 302 is continuously computing moving averages of the rate of commands being scheduled to respond real time to changes in the workload by updating the aging rate.

The logic 414 can also compute the aging rate based on other factors, such as the size of the pending queue and the size of the age counter per entry. In one example, the aging rate is configured to be a multiple of the queue size (e.g., 2×, 3×, 4×, 8×, etc.). In one such example, if the aging rate is based on 2× the queue size and the queue has 32 entries, a command would wait for 64 commands to reach starvation. In another example where the aging rate is based on 4× the queue size and the queue has 32 entries, a command would wait for 128 commands to reach starvation. This minimum starvation time would vary with workloads (e.g., if commands are scheduled quickly, the starvation time would be relatively low, and if the commands are scheduled more slowly, the starvation time would be higher). Regardless of which factors the aging rate is based on, in one example, each of the multiple queues has an independent aging rate based on the average rate of scheduled commands for that queue.

Thus, unlike conventional fixed age tracking, workload-dependent age tracking slows down the aging rate when the delay in scheduling commands from that queue increases. Consider an example of a pending queue with 32 entries and a 10-bit conventional fixed age counter per entry. In one such example where fixed age tracking is used it would take 1024 clocks (2¹⁰) to reach starvation irrespective of the workload. Therefore, if the workload pauses for 1024 clocks, all pending commands in the queue will reach starvation and require higher priority. In contrast, workload-dependent age tracking would decrease the aging rate in response to pauses in the workload. Slowing down aging in response to delays in scheduling commands from a queue can prevent the condition in which many or all commands in a queue enter a starvation condition, which prevents errors and improves system performance.

In the event that the starvation condition does occur in a pending command queue, temporarily halting or suspending aging can prevent additional commands in the queue from becoming starved. For example, referring to FIG. 4C, when the logic 414 receives the starve signal indicating that an entry in a corresponding queue is starved, the logic 414 halts aging until the starved command is serviced. In one such example, aging is halted by suspending the aging/starvation tick provided for incrementing the corresponding age counter (e.g., 311A or 311B). Therefore, when aging is halted, the age counters 311A and 311B stay the same (e.g., are not incremented) while a command is starved. Aging is resumed for the commands in the queue when the starved memory access command has been scheduled or serviced. Halting aging when one command in a queue is starved can prevent the scenario in which age granularity is lost due to all commands in the queue becoming starved.

Note that in the example of FIG. 3, the pending queue 308C for low latency media management commands does not include workload-dependent age tracking logic. In one such example, the commands in the pending command queue 308C will be serviced in a timely manner due to their high priority and the infrequency of starved commands in the other queues, rendering workload-dependent age tracking unnecessary for the low latency queue 308C. Thus, in the example of FIG. 3, the age counter 311C for the low latency commands can be incremented either based on the clock, based on the average scheduling rate of commands, or based on another factor.

FIG. 5 is an example of a finite state machine (FSM) diagram for the workload-dependent age tracking logic 414. The state machine 500 begins in an idle state 502. The idle state 502 represents an initial state, such as after startup/boot or reset, or other initial state. In the idle state 502, there is insufficient information to determine the aging rate because the number of commands received is insufficient to determine the average scheduling rate for the queue. Therefore, in the idle state 502, there is no aging of commands in the queue while the logic 414 waits to receive grants.

The initialization state 504 represents a state in which calibration or measurements are being performed. In the initialization state 504, the logic 414 accumulates an initial running average of the number of grants but is not yet aging the commands in the queue. After a predetermined number of commands have been received, the state machine moves to the start state 506. In the start state 506, the logic 414 begins to generate the aging/starvation tick signal to age commands in the queue based on the running average of scheduled commands for the queue. The state machine moves from the start state 506 to the run state 508 in which the logic 414 counts the number of clock cycles between grants for the queue. Once a grant is received, the state machine moves to the update state 510 to reload the starvation tick timer (to determine when to assert the aging/starvation tick signal) using the latest running average.

The state machine then loops between the start state 506, run state 508, and the update state 510, to continue computing the running average command schedule rate for the queue and generate the aging/starvation tick to age the commands in the queue based on that average command schedule rate. If a starve signal is received that indicates an entry in the queue is starved, the state machine moves to the starve state 512 to halt aging. In one such example, once the starved entry is serviced, the state machine resets the counters and moves to the idle state to restart the process.

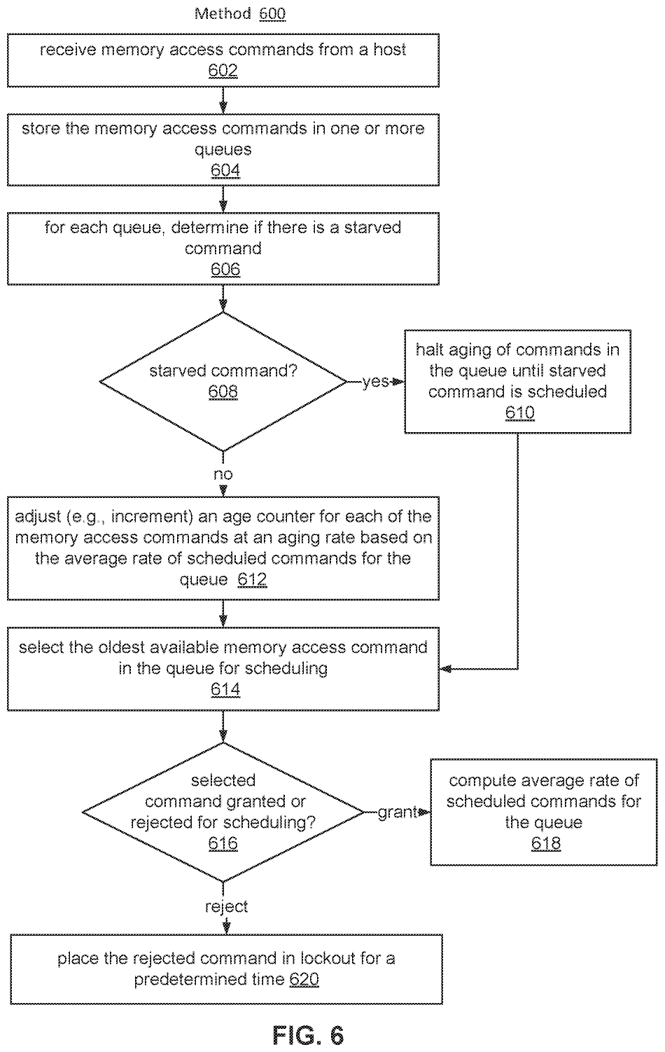

FIG. 6 illustrates a flow diagram of an example of a method of workload-dependent command aging. For example, the method 600 may be performed by the logic 302 of FIG. 3. The method involves receiving memory access commands from a host, at block 602. For example, referring to FIG. 3, the I/O interface circuitry 307 receives memory access commands from one or more processors (e.g., a host processor). The memory access commands are stored in one or more queues, at block 604. For example, referring to FIG. 3, the memory access commands are stored in the queues 308A and/or 308B.

For each queue, control logic determines whether there is a starved command in the queue, at block 606. If there is a starved command, block 608 YES branch, then aging is halted for commands in the queue until the starved command is scheduled or service, at block 610. If there are no starved commands in the queue, block 608 NO branch, the age counters corresponding to each of the memory access commands (e.g., entries of the queue) are adjusted, at block 612. The age counters are adjusted at an aging rate based on the average rate of scheduled commands for the queue. Adjusting the age counters for a queue involves incrementing or decrementing the counters. For example, referring to FIG. 3, the workload-dependent age tracking logic 315A determines the average rate of scheduled commands for the queue 308A and generates the aging/starvation tick based on the rate. The aging/starvation tick causes the age counters 311A corresponding to each of the commands in the queue 308A to be incremented.

Referring again to FIG. 6, the method involves selecting the oldest available memory access command in the queue for scheduling, at block 614. In one example, the oldest available command is the command that is most aged based on the counters, and which is not flagged as unavailable for another reason (such as being in a lockout mode due to a prior rejection). If more than one command has the oldest age, then the command can be selected based on position in queue using a round robin algorithm. For example, referring to FIG. 3, the pending queue arbiter 310A selects the oldest available command from the queue 308A for scheduling. The arbiter 310A sends a signal to the NVM scheduler indicating that a valid command is selected from the queue 308A, and also indicates whether it is high priority (e.g., due to being starved).

Referring again to FIG. 6, if the selected command from a queue is granted access to the bus, block 616 GRANT, the average rate of scheduled commands for that queue is computed, at block 618. For example, referring to FIG. 3, the NVM scheduler sends the grant signal to the workload-dependent age tracking logic 315A, 315B to indicate whether or not the command from that queue was selected for scheduling. If the command from the queue was selected (grant), then average scheduling rate is updated based on the number of clocks elapsed between the previous grant and the current grant.

Referring again to FIG. 6, if the queue is not granted access to the bus, block 616 REJECT, the rejected command is placed in a lockout mode for a predetermined time, at block 620. In one such example, the duration of the lockout mode corresponds to the delay times for the memory media. Placing the command in lockout mode can involve, for example, setting a lockout bit corresponding to that command or another means for indicating a command's state. For example, referring to FIG. 3, the control logic sets a lockout bit 313A for the corresponding entry of the queue 308A. Similarly, a lockout bit 313B can be set for the corresponding entry of the queue 308B. After the predetermined time has passed, the command can exit lockout mode and is again available for scheduling.

Referring to FIG. 6, the method continues both receiving and storing commands at blocks 602 and 604 as space in the queues becomes available. The method also continues the workload-dependent aging in blocks 606-620.

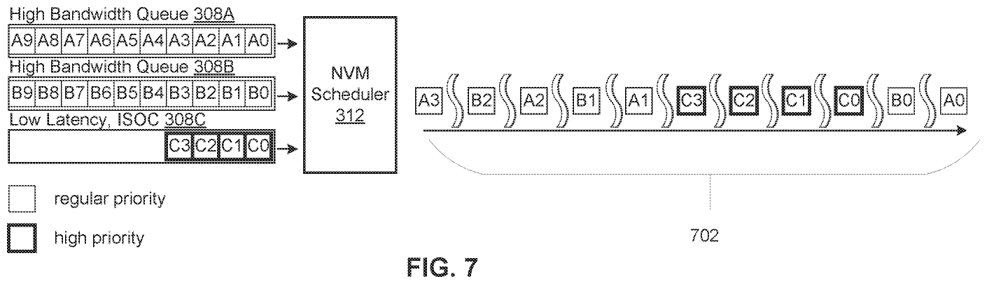

FIG. 7 is a diagram depicting an example of command arbitration and scheduling for a workload using workload-dependent command aging. In the example of FIG. 7, the queue 308A has pending commands A0-A9, the queue 308B has pending commands B0-B9, and the queue 308C has pending commands C0-C3. Due to workload-dependent age tracking, none of the commands from the high-bandwidth queues 308A and 308B are starved, and therefore are not flagged as high priority (i.e., the commands are regular priority as indicated by the non-bold outline). The commands C0-C3 are high priority due to the command type (e.g., media management commands) as indicated by the bold outline. The NVM scheduler 312 receives commands selected from each of the queues 308A-308C and selects one of the queues as a source of commands for scheduling. The resulting scheduled commands 702 are in the correct order; the low latency commands are scheduled ahead of most of the memory access commands, and therefore the latency for those commands is low, as expected. Thus, workload-dependent aging can improve QoS by enabling the accurate tracking of aging and preventing excessive starvation in pending command queues. The accurate age tracking and low rate of starvation enables low latency servicing of high priority media management traffic to maintain a low error rate.

The workload-dependent age tracking described herein can be implemented for various non-volatile memory technologies. One memory technology for which workload-dependent age tracking can be implemented is cross-point memory.

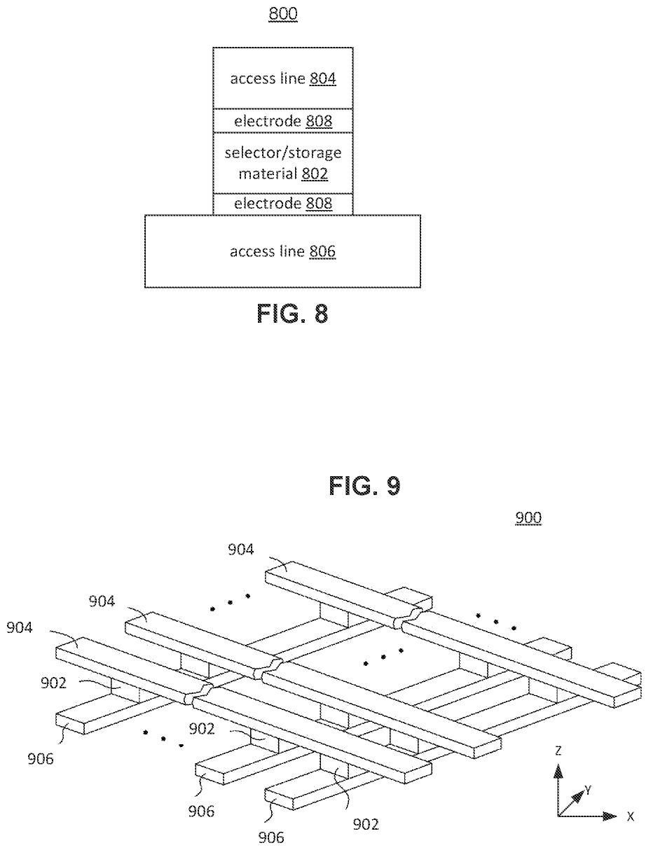

FIG. 8 illustrates an example of a cross-point memory cell that can be accessed using techniques described herein.

FIG. 8 illustrates a memory cell 800. The memory cell 800 includes one or more layers of material 802 to store data and aid in selection of the memory cell 800. For example, the memory cell 800 can include a storage material 802 (e.g., to form a memory element), a selector material (e.g., to form the switch element), or both, between access lines 804 and 806. In one example, the memory cell includes a layer of storage material and a separate layer of selector material. In one example, both the selector and the storage element have tunable threshold voltages. In one example, the memory cell 800 includes a self-selecting material that exhibits both memory and selection effects. A self-selecting material is a storage material that enables selection of a memory cell in an array without requiring a separate layer of material for selection of the cell. In one example, a self-selecting memory cell includes a single layer of material that acts as both a selector element to select the memory cell and a memory element to store a logic state. A material exhibits memory effects if the material can be put in one of multiple stable states (e.g., via a write operation), and subsequently read back (e.g., via a read operation). In one example, the switch element formed from the select material is an ovonic switch.

The techniques described herein apply generally to non-volatile memory and are not dependent on or specific to a particular storage material. However, some non-limiting examples of cross-point memory storage material follow.

In some examples, the storage material is a phase change material. In other examples, the storage material can be in one or multiple stable states without a change in phase. In one example, the memory element, switching element, or both are amorphous semiconductor threshold switches (e.g., ovonic threshold switches) using an amorphous material such as an amorphous chalcogenide material or other amorphous material. An ovonic threshold switch remains in an amorphous state which distinguishes it from an ovonic memory, which generally changes between amorphous and crystalline states. In one example, an ovonic memory is used in series with an ovonic threshold switch. In such case, the ovonic threshold switch operates as the switch element for the ovonic memory. Whether the memory material of the memory cell changes phase or not, in one example, the memory could be referred to as a resistance-based memory. In a resistance-based memory, the bit stored by a memory cell is based on the resistive state of the memory cell.

Examples of storage material can include one or more of: tellurium (Te), selenium (Se), germanium (Ge), antimony (Sb), bismuth (Bi), lead (Pb), tin (Sn), indium (In), silver (Ag), arsenic (As), sulfur (S), phosphorus (P), molybdenum (Mo), gallium (Ga), aluminum (Al), oxygen (O), nitrogen (N), chromium (Cr), gold (Au), niobium (Nb), palladium (Pd), cobalt (Co), vanadium (V), nickel (Ni), platinum (Pt), titanium (Ti), tungsten (W), tantalum (Ta) or other materials. For example, the storage material may include one or more chalcogenide materials such as such as Te—Se, Ge—Te, In—Se, Sb—Te, Ge—Sb, Ta—Sb—Te, Ga—Sb, In—Sb, As—Te, As—Se, Al—Te, As—Se—Te, Ge—Sb—Te, Ge—As—Se, Te—Ge—As, V—Sb—Se, Nb—Sb—Se, In—Sb—Te, In—Se—Te, Te—Sn—Se, V—Sb—Te, Se—Te—Sn, Ge—Se—Ga, Mo—Sb—Se, Cr—Sb—Se, Ta—Sb—Se, Bi—Se—Sb, Mo—Sb—Te, Ge—Bi—Te, W—Sb—Se, Ga—Se—Te, Ge—Te—Se, Cr—Sb—Te, Sn—Sb—Te, W—Sb—Te, Sn—Sb—Bi, In—Sb—Ge, As—Sb—Te, Ge—Te—Ti, Te—Ge—Sb—S, Te—Ge—Sn—O, Te—Ge—Sn—Au, Pd—Te—Ge—Sn, In—Se—Ti—Co, Ge—Sb—Te—Pd, Ge—Sb—Te—Co, Sb—Te—Bi—Se, Ag—In—Sb—Te, Ge—Se—Te—In, As—Ge—Sb—Te, Se—As—Ge—In, Ge—Sb—Se—Te, Ge—Sn—Sb—Te, Ge—Te—Sn—Ni, Ge—Te—Sn—Pd, and Ge—Te—Sn—Pt, Si—Ge—As—Se, In—Sn—Sb—Te, Ge—Se—Te—Si, Si—Te—As—Ge, Ag—In—Sb—Te, Ge—Se—Te—In—Si, Se—As—Ge—Si—In, or other materials capable of being programmed to one of multiple states. One or more elements in a chalcogenide material may be dopants. For example, the storage material may include dopants such as: aluminum (Al), oxygen (O), nitrogen (N), silicon (Si), carbon (C), boron (B), zirconium (Zr), hafnium (Hf), or a combination thereof. The storage material may include other materials or dopants not explicitly listed.

As mentioned above, some memory cells include a separate layer of selector material to form a switch element. The selector material may include a chalcogenide material (e.g., a chalcogenide glass) or other material capable of operating as a selection element. In one example, the selector material includes one or more of: silicon (Si), germanium (Ge), selenium (Se), arsenic, tellurium (Te), or other materials. In one example, the selector material includes Si—Ge—As—Se, As—Ge—Te—Si, or other selector material. The selector material may also include dopants such as: aluminum (Al), oxygen (O), nitrogen (N), silicon (Si), carbon (C), boron (B), zirconium (Zr), hafnium (Hf), or a combination thereof. The selector material may include other materials or dopants not explicitly listed.

The access lines 804, 806 electrically couple the memory cell 800 with circuitry that provides power to and enables access to the memory cell 800. The term “coupled” can refer to elements that are physically, electrically, and/or communicatively connected either directly or indirectly, and may be used interchangeably with the term “connected” herein. Physical coupling can include direct contact. Electrical coupling includes an interface or interconnection that allows electrical flow and/or signaling between components. Communicative coupling includes connections, including wired and wireless connections, that enable components to exchange data. The access lines 804, 806 can be referred to as a bit line and word line, respectively. The word line is for accessing a particular word in a memory array and the bit line is for accessing a particular bit in the word. The access lines 804, 806 can be composed of one or more metals including: Al, Cu, Ni, Cr, Co, Ru, Rh, Pd, Ag, Pt, Au, Ir, Ta, and W; conductive metal nitrides including TiN, TaN, WN, and TaCN; conductive metal silicides including tantalum silicides, tungsten silicides, nickel silicides, cobalt silicides and titanium silicides; conductive metal silicide nitrides including TiSiN and WSiN; conductive metal carbide nitrides including TiCN and WCN, or any other suitable electrically conductive material.

In one example, electrodes 808 are disposed between storage material 802 and access lines 804, 806. Electrodes 808 electrically couple access lines 804, 806 with storage material 802. A memory cell with separate layers of storage and selector material may also include an electrode between the layers of storage and selector material. Electrodes 808 can be composed of one or more conductive and/or semiconductive materials such as, for example: carbon (C), carbon nitride (CₓN_{y}); n-doped polysilicon and p-doped polysilicon; metals including, Al, Cu, Ni, Cr, Co, Ru, Rh, Pd, Ag, Pt, Au, Ir, Ta, and W; conductive metal nitrides including TiN, TaN, WN, and TaCN; conductive metal silicides including tantalum silicides, tungsten silicides, nickel silicides, cobalt silicides and titanium silicides; conductive metal silicides nitrides including TiSiN and WSiN; conductive metal carbide nitrides including TiCN and WCN; conductive metal oxides including RuO₂, or other suitable conductive materials.

FIG. 9 illustrates a portion of a memory cell array 900, which can include a memory cell such as the memory cell 800 of FIG. 8. The memory cell array 900 is an example of a cross-point memory array. The memory cell array 900 includes a plurality of access lines 904, 906, which can be the same or similar as the access lines 804, 806 described with respect to FIG. 8. Access lines 904, 906 can be referred to as bitlines and wordlines. In the example illustrated in FIG. 9, the bitlines (e.g., access lines 904) are orthogonal to the wordlines (e.g., access lines 906). A storage material 902 is disposed between the access lines 904, 906. In one example, a “cross-point” is formed at an intersection between a bitline and a wordline. A memory cell is created from the storage material 902 between the bitline and wordline where the bitline and wordline intersect. The storage material 902 can be a chalcogenide material, phase change material, both a chalcogenide material and phase change material, or other storage material. In one example, the access lines 904, 906 are composed of one or more conductive materials such as the access lines 804, 806 described above with respect to FIG. 8.

Although a single level or tier of memory cells is shown in FIG. 9 for the sake of clarity, memory cell array 900 typically includes multiple levels or tiers of non-volatile memory cells (e.g., in the z-direction). Nonvolatile memory devices including multiple tiers of cross-point memory cells may be referred to as three-dimensional (3D), multi-level, or multi-tiered cross-point memory devices. The FIGS. 8 and 9 illustrate an example of a memory cell and array. However, the techniques described herein can be implemented for memory technologies having different materials or structures than the examples described in FIGS. 8 and 9.

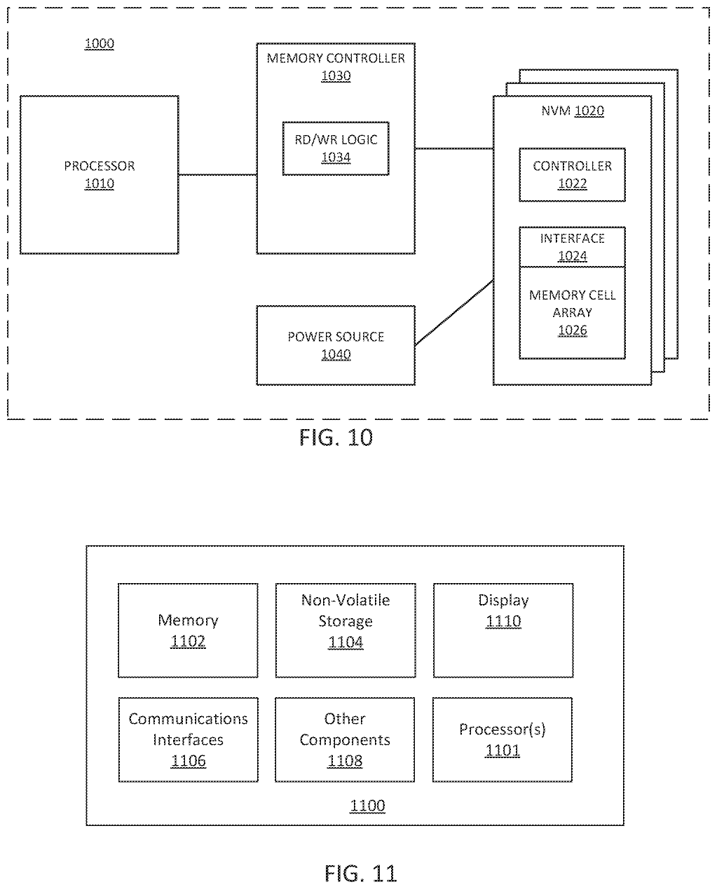

FIG. 10 is a block diagram of a system that can include a non-volatile memory device in accordance with examples described herein.

System 1000 includes components of a memory subsystem having cross-point memory 1020 to store and provide data in response to operations of processor 1010. The system 1000 receives memory access requests from a host or a processor 1010, which is processing logic that executes operations based on data stored in cross-point memory 1020 or generates data to store in cross-point memory 1020. The processor 1010 can be or include a host processor, central processing unit (CPU), microcontroller or microprocessor, graphics processor, peripheral processor, application specific processor, or other processor, and can be single core or multicore.

The system 1000 includes a memory controller 1030 (e.g., host memory controller), which represents logic to interface with cross-point memory 1020 and manage access to data stored in the memory. In one example, the memory controller 1030 is integrated into the hardware of processor 1010. In one example, the memory controller 1030 is standalone hardware, separate from the processor 1010. The memory controller 1030 can be a separate circuit on a substrate that includes the processor. The memory controller 1030 can be a separate die or chip integrated on a common substrate with a processor die (e.g., as a system on a chip (SoC)). In one example, the memory controller 1030 is an integrated memory controller (iMC) integrated as a circuit on the processor die. In one example, at least some of cross-point memory 1020 can be included on an SoC with the memory controller 1030 and/or the processor 1010.

In the illustrated example, the memory controller 1030 includes read/write logic 1034, which includes hardware to interface with the cross-point memory 1020. The logic 1034 enables the memory controller 1030 to generate read and write commands to service requests for data access generated by the execution of instructions by processor 1010.

The memory resources or cachelines in the cross-point memory 1020 are represented by a memory cell array 1026, which can include a cross-point array. The cross-point memory 1020 includes an interface 1024 (e.g., interface logic) to control the access to the memory device array 1026. The interface 1024 can include decode logic, including logic to address specific rows or columns, bit lines or word lines, or otherwise address specific bits of data. The controller 1022 represents an on-die (e.g., on the same die as the memory array) or on-package (e.g., in the same package as the memory array) controller on cross-point memory 1020 to control its internal operations to execute commands received from memory controller 1030. For example, the controller 1022 can control any of timing, voltage levels, addressing, I/O (input/output) margining, scheduling, and error correction for cross-point memory 1020. A power source 1040 is connected to the cross-point memory 1020 to provide one or more voltage rails for operation of the cross-point memory 1020.

FIG. 11 provides an exemplary depiction of a computing system 1100 (e.g., a smartphone, a tablet computer, a laptop computer, a desktop computer, a server computer, etc.). As observed in FIG. 11, the system 1100 may include one or more processors or processing units 1101. The processor(s) 1101 may include one or more central processing units (CPUs), each of which may include, e.g., a plurality of general-purpose processing cores. The processor(s) 1101 may also or alternatively include one or more graphics processing units (GPUs) or other processing units. The processor(s) 1101 may include memory management logic (e.g., a memory controller) and I/O control logic. The processor(s) 1101 can be similar to, or the same as, the processor 1010 of FIG. 10.

The system 1100 also includes memory 1102 (e.g., system memory), non-volatile storage 1104, communications interfaces 1106, a display 1110 (e.g., touchscreen, flat-panel), and other components 1108. The other components may include, for example, a power supply (e.g., a battery or/or other power supply), sensors, power management logic, or other components. The communications interfaces 1106 may include logic and/or features to support a communication interface. For these examples, communications interface 1106 may include one or more communication interfaces that operate according to various communication protocols or standards to communicate over direct or network communication links or channels. Direct communications may occur via use of communication protocols or standards described in one or more industry standards (including progenies and variants) such as those associated with the PCIe specification. Network communications may occur via use of communication protocols or standards such those described in one or more Ethernet standards promulgated by IEEE. For example, one such Ethernet standard may include IEEE 802.3. Network communication may also occur according to one or more OpenFlow specifications such as the OpenFlow Switch Specification. Other examples of communications interfaces include, for example, a local wired point-to-point link (e.g., USB) interface, a wireless local area network (e.g., WiFi) interface, a wireless point-to-point link (e.g., Bluetooth) interface, a Global Positioning System interface, and/or other interfaces.

The computing system also includes non-volatile storage 1104, which may be the mass storage component of the system. The non-volatile storage 1104 can be similar to, or the same as, the cross-point memory 1020 of FIG. 10, described above. A non-volatile memory (NVM) device is a type of memory whose state is determinate even if power is interrupted to the device. In one embodiment, the NVM device may include block or byte-addressable, write-in-place memories. Examples may include, but are not limited to, single or multi-level Phase Change Memory (PCM) or phase change memory with a switch (PCMS), non-volatile types of memory that include chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other types of block or byte-addressable, write-in-place memory. In one example, the non-volatile storage 1104 may include mass storage that is composed of one or more SSDs (solid state drives), DIMMs (dual in line memory modules), or other module or drive. The non-volatile storage 1104 may implement techniques in accordance with examples described herein.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine-readable storage medium can cause a machine to perform the functions or operations described and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Examples of workload-dependent age tracking follow.

Example 1: a memory device including input/output interface circuitry to receive memory access commands from a processor, a queue to store the memory access commands, an age counter for each of the memory access commands in the queue, and hardware logic to: adjust the age counter for each of the memory access commands at an aging rate based on an average rate of scheduled commands for the queue, and select an oldest memory access command for scheduling based on the ages of the memory access commands in the queue.

Example 2: The memory device of example 1, wherein: the aging rate is based on a moving average of the rate of scheduled commands for the queue.

Example 3: The memory device of examples 1 or 2, wherein: the aging rate increases when the average rate of scheduled commands for the queue increases, and the aging rate decreases when the average rate of scheduled commands for the queue decreases.

Example 4: The memory device of any of examples 1-3, wherein the hardware logic to adjust the age counter for each of the memory access commands is to: increment the age counter for each of the memory access commands in the queue after every X number of commands from the queue have been scheduled, wherein X is a positive integer greater than or equal to one.

Example 5: The memory device of any of examples 1-4, further including multiple queues to store memory access commands from the processor, and wherein each of the multiple queues has an independent aging rate based on the average rate of scheduled commands for that queue.

Example 6: The memory device of any of examples 1-5, wherein the hardware logic is to: receive, from scheduling logic, a rejection of the selected memory access command, and in response to the rejection, place the selected memory access command in lockout mode for a predetermined time, wherein a command in the lockout mode will not be selected for scheduling.

Example 7: The memory device of example 6, wherein the logic to place the selected memory access command in lockout mode is to: set a lockout bit for the memory access command.

Example 8: The memory device of any of examples 1-7, wherein the hardware logic is to: halt aging for the memory access commands in the queue when a memory access command in the queue is starving.

Example 9: The memory device of example 8, wherein the hardware logic is to: resume aging for the memory access commands in the queue when the starved memory access command has been scheduled.

Example 10: A system including a processor, and a memory device coupled with the processor, wherein the memory device is in accordance with any of examples 1-9.

Example 11: A method including: receiving memory access commands from a host, storing the memory access commands in a queue, incrementing an age counter for each of the memory access commands in the queue at an aging rate based on an average rate of scheduled commands for the queue, and selecting an oldest memory access command for scheduling based on the ages of the memory access commands in the queue.

Example 12: the method of example 11, wherein: the aging rate is based on a moving average of the rate of scheduled commands for the queue.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

The hardware design embodiments discussed above may be embodied within a semiconductor chip and/or as a description of a circuit design for eventual targeting toward a semiconductor manufacturing process. In the case of the later, such circuit descriptions may take of the form of a (e.g., VHDL or Verilog) register transfer level (RTL) circuit description, a gate level circuit description, a transistor level circuit description or mask description or various combinations thereof. Circuit descriptions are typically embodied on a computer readable storage medium (such as a CD-ROM or other type of storage technology).

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow.

What is claimed is:

1. A memory device comprising:
input/output interface circuitry to receive memory access commands from a processor;
a queue to store the memory access commands;
an age counter for each of the memory access commands in the queue; and
hardware logic to:
adjust the age counter for each of the memory access commands at an aging rate based on an average rate of scheduled commands for the queue; and
select an oldest memory access command for scheduling based on the ages of the memory access commands in the queue.

2. The memory device of claim 1, wherein:
the aging rate is based on a moving average of the rate of scheduled commands for the queue.

3. The memory device of claim 1, wherein:
the aging rate increases when the average rate of scheduled commands for the queue increases; and
the aging rate decreases when the average rate of scheduled commands for the queue decreases.

4. The memory device of claim 1, wherein the hardware logic to adjust the age counter for each of the memory access commands is to:
increment the age counter for each of the memory access commands in the queue after every X number of commands from the queue have been scheduled, wherein X is a positive integer greater than or equal to one.

5. The memory device of claim 1, further comprising:
multiple queues to store memory access commands from the processor; and
wherein each of the multiple queues has an independent aging rate based on the average rate of scheduled commands for that queue.

6. The memory device of claim 1, wherein the hardware logic is to:
receive, from scheduling logic, a rejection of the selected memory access command; and
in response to the rejection, place the selected memory access command in lockout mode for a predetermined time, wherein a command in the lockout mode will not be selected for scheduling.

7. The memory device of claim 6, wherein the logic to place the selected memory access command in lockout mode is to:
set a lockout bit for the memory access command.

8. The memory device of claim 1, wherein the hardware logic is to:
halt aging for the memory access commands in the queue when a memory access command in the queue is starving.

9. The memory device of claim 8, wherein the hardware logic is to:
resume aging for the memory access commands in the queue when the starved memory access command has been scheduled.

10. A system comprising:
a processor; and
a memory device coupled with the processor, the memory device comprising:
input/output interface circuitry to receive memory access commands from a processor;
a queue to store the memory access commands;
an age counter for each of the memory access commands in the queue; and
hardware logic to:
adjust the age counter for each of the memory access commands at an aging rate based on an average rate of scheduled commands for the queue; and
select an oldest memory access command for scheduling based on the ages of the memory access commands in the queue.

11. The system of claim 10, wherein:
the aging rate is based on a moving average of the rate of scheduled commands for the queue.

12. The system of claim 10, wherein:
the aging rate increases when the average rate of scheduled commands for the queue increases; and
the aging rate decreases when the average rate of scheduled commands for the queue decreases.

13. The system of claim 10, wherein the hardware logic to adjust the age counter for each of the memory access commands is to:
increment the age counter for each of the memory access commands in the queue after every X number of commands from the queue have been scheduled, wherein X is a positive integer greater than or equal to one.

14. The system of claim 10, further comprising:
multiple queues to store memory access commands from the processor; and
wherein each of the multiple queues has an independent aging rate based on the average rate of scheduled commands for that queue.

15. The system of claim 10, wherein the hardware logic is to:
receive, from scheduling logic, a rejection of the selected memory access command; and
in response to the rejection, place the selected memory access command in lockout mode for a predetermined time, wherein a command in the lockout mode will not be selected for scheduling.

16. The system of claim 15, wherein the logic to place the selected memory access command in lockout mode is to:
set a lockout bit for the memory access command.

17. The memory device of claim 10, wherein the hardware logic is to:
halt aging for the memory access commands in the queue when a memory access command in the queue is starving.

18. The memory device of claim 17, wherein the hardware logic is to:
resume aging for the memory access commands in the queue when the starved memory access command has been scheduled.

19. A method comprising:
receiving memory access commands from a host;
storing the memory access commands in a queue;
incrementing an age counter for each of the memory access commands in the queue at an aging rate based on an average rate of scheduled commands for the queue; and
selecting an oldest memory access command for scheduling based on the ages of the memory access commands in the queue.

20. The method of claim 19, wherein:
the aging rate is based on a moving average of the rate of scheduled commands for the queue.
